(19) United States
(12) Patent Application Publication
(10) Pub. No.: US 2025/0244766 A1
(43) Pub. Date: Jul. 31, 2025

(54) ROBOT FLOORPLAN NAVIGATION

(71) Applicant: ObjectVideo Labs, LLC, Tysons, VA (US)

(72) Inventors: Ethan Shayne, Clifton Park, NY (US); Donald Gerard Madden, Columbia, MD (US); Timon Meyer, Centreville, VA (US); Aditya Shiwaji Rasam, McLean, VA (US)

(21) Appl. No.: 19/024,291

(22) Filed: Jan. 16, 2025

Related U.S. Application Data
(60) Provisional application No. 63/627,474, filed on Jan. 31, 2024.

(51) Int. Cl. G05D 1/249; G05D 1/246; G05D 101/20; H04W 4/38

(52) U.S. Cl. CPC G05D 1/249; G05D 1/246; H04W 4/38; G05D 2101/20

(57) ABSTRACT

Methods, systems, and apparatus, including computer programs encoded on computer-storage media, for robot navigation. In some implementations, a method includes obtaining sensor data captured by one or more sensors located at a property over a time period; detecting an object represented in the sensor data; detecting, using the detected object and multiple subsets of the sensor data, a movement pattern of the object over the time period; determining an area navigable for a robot at the property using the detected movement pattern of the object over the time period; and providing, to the robot, an indication of the area navigable for the robot.

### CROSS-REFERENCE TO RELATED APPLICATION

This application claims the benefit of U.S. Provisional Application No. 63/627,474, filed Jan. 31, 2024, and titled “ROBOT FLOORPLAN NAVIGATION,” which is incorporated by reference.

### BACKGROUND

A monitoring system for a property can include various components including sensors, e.g., cameras, and other devices. For example, the monitoring system may use a robot, such as a drone, that navigates around a property to perform one or more missions. The robot can capture sensor data.

### SUMMARY

This specification describes techniques for robot navigation using a floorplan or another appropriate type of map generated from obtained sensor data. Other types of maps can include path plans, e.g., plans that include path information whether the plan is a floorplan or another appropriate type of plan. Although the examples described in this specification generally refer to a floorplan, other examples can include other types of maps. The sensor data can include sensor data from a drone configured to follow a person at a property, a sensor attached to a person at the property, or a combination of both. The sensor data can include data from one or more sensors of a property's monitoring system.

Generated floorplans can be used by one or more robots, such as aerial or land drones, to navigate about a property. Generated floorplans can include additional details indicating high traffic areas, areas to avoid, object permanency, among other features. Floorplans can be generated with additional features describing elements of a property using obtained sensor data. Routes for navigating through a property can account for one or more features of a generated floorplan to, e.g., avoid moving in crowded areas, avoid disturbing sleeping occupants of a property, avoid disturbing pets or other objects, maintain a threshold distance from objects with threshold permanency values, or optimize a route from a first location in a property to a second location in a property, or a combination of these.

In some implementations, a robot uses features of a generated floorplan as part of a localization process. For example, robots can perform localization periodically to adjust a position value stored in a given robot's memory indicating where the robot interprets its own location to be. A robot's interpretation of its location can drift over time due to error in inertial monitoring among other phenomena. Localization can include identifying an object in space and, using a known location of the object, determining a location of the robot in relation to the location of the object with the known location. A given robot can obtain a generated floorplan and determine a permanency value of an object to be used for localization. A robot can perform localization using an object if a permanency value of the object satisfies a threshold permanency value and can scan a room for another object if the permanency value of the object does not satisfy a threshold permanency value.

In some cases, a system can use observed movement of an object to adjust a location of an object, whether the same object or a different object, to be used for robot localization. For example, a camera mounted at a property can observe a chair having moved 30 cm. The system described herein can determine the new location of the chair, e.g., using image detection processes, and update a location of the chair in the floorplan to the newly determined location. The newly determined location can then be used for localization by a robot—e.g., next time a robot is in the room with the chair and a localization process is activated by the robot or the system.

In some implementations, generated floorplans, and associated generated routes within one or more properties, are updated over time, e.g., by a robot, backend processing system, control unit, or a combination of two or more of these. For example, floorplans can be generated for particular times of day or particular conditions. A floorplan used by one or more robots can be updated to match a current lighting condition or to a lighting condition that matches a typical lighting condition corresponding to when a given robot is predicted or scheduled to be active. Lighting conditions can include differences in color or shadows—e.g., caused by a change to artificial light at night, natural light in the morning, lights turned off when an occupant is away, or a combination of one or more of these. In some implementations, floorplans are generated for property conditions. For example, floorplans can be generated for alarm set conditions and alarm not set conditions—e.g., restricting robot movement outside the house when an alarm condition is set or not set.

In some cases, a floorplan can include indications of an appearance one or more lighting conditions of locations at a property. Indications can include descriptions of what kind of lighting was detected at a location at the property. The indications can be an appearance of the lighting conditions in that the measurements might not be completely accurate, might change over time, or might reflect how an area at the location is depicted in an image of the area. In some examples, the indications can represent measurements for matching a current lighting condition to a lighting condition stored in the floorplan. If a sensor detects a new lighting condition—e.g., a lighting condition that does not match a previously stored lighting condition within a threshold level of matching or changes an appearance of an area beyond a threshold level of change-the system can add indications of the new lighting condition to a floorplan. The new lighting condition can then be used for navigation of a robot. In some cases, a transformation of an appearance can be generated that is suited to a robot's sensors—e.g., black and white from RGB images, among others.

In some implementations, generated floorplans include confidence values. A given robot can use confidence values in one or more locations to determine, based on a current location, a velocity of travel—e.g., speeding up when confidence of surrounding elements is comparatively high and slowing down when confidence of surrounding elements is comparatively low.

In general, one innovative aspect of the subject matter described in this specification can be embodied in methods that include the actions of obtaining sensor data captured by one or more sensors located at a property over a time period; detecting an object represented in the sensor data; detecting, using the detected object and multiple subsets of the sensor data, a movement pattern of the object over the time period; determining an area navigable for a robot at the property using the detected movement pattern of the object over the time period; and providing, to the robot, an indication of the area navigable for the robot.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, detecting the movement pattern of the object includes: detecting an object moving at the property. In some implementations, determining the area navigable for the robot using the detected movement pattern of the object over the time period includes: identifying an area traversed by the object moving at the property as the area navigable for the robot.

In some implementations, actions include generating a first map using the area navigable for the robot, where providing the indication includes providing the map to the robot as the indication of the area navigable for the robot. In some implementations, actions include obtaining second sensor data captured by the one or more sensors located at the property over a second, different time period; determining, using the second sensor data, a change in property condition; and in response to determining the change in property condition, generating a second map using the second sensor data, where the second map is different from the first map and associated with the second, different time period. In some implementations, the change in property condition includes a change in lighting condition, and where generating the second map using the second sensor data includes: updating one or more objects represented in the first map to represent the change in lighting condition.

In some implementations, detecting the movement pattern of the object includes: detecting the object did not move, where determining the area navigable for the robot at the property includes determining an area that does not include an area that includes the object.

In some implementations, actions include generating, using the detected movement of the first object, a permanence value of the first object, where determining the area navigable for the robot at the property includes determining, using the permanence value of the first object, the area navigable for the robot.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification improve the mapping of routes and areas navigable to robots at a property compared to other systems. For example, systems can use sensors for monitoring a property to detect people or other objects at a property. Systems can use the detection of people or other objects to determine one or more of (i) permanency values of objects or (ii) common routes, e.g., movement patterns, used by people. The use of a permanency value, data for a common route, or both, to determine routes or navigable areas can improve robot navigation at a property when the robot uses the routes or navigable areas. Systems and methods described in this specification can improve accuracy of mapping floorplans, e.g., by updating floorplans, generating multiple floorplans, or both, using sensor data obtained from sensors of a property—e.g., to represent aspects of property at different times or different lighting conditions.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an example of a system for robot floorplan navigation.

FIG. 2 is a flow diagram illustrating an example of a process for robot floorplan navigation.

FIG. 3 is a diagram illustrating an example of an environment for monitoring a property.

Like reference numbers and designations in the various drawings indicate like elements.

### DETAILED DESCRIPTION

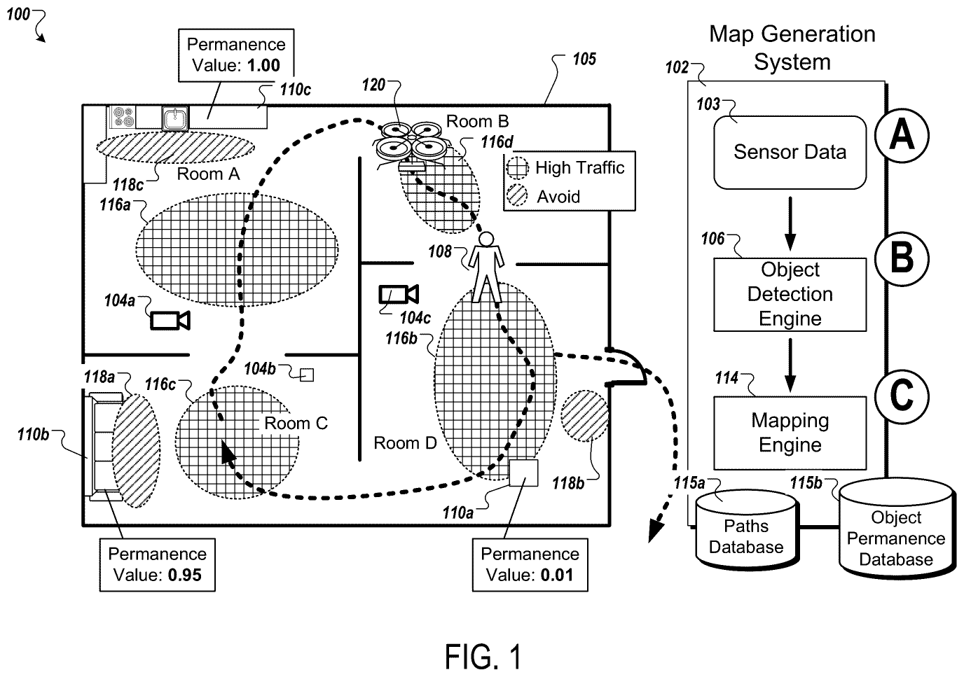

FIG. 1 is a diagram showing an example of an environment 100 for robot navigation. The environment 100 includes robot 120 at a property 105, and a map generation system 102. Data obtained by the robot 120 can be processed by the map generation system 102 to generate a floorplan or update an existing floorplan for the property 105. The map generation system 102 can include one or more computers, either affixed to the robot 120 or communicably connected to the robot 120, configured to process data from the robot 120. The robot 120 can include one or more propulsion devices—e.g., propellers or wheels.

In stage A, the map generation system 102 obtains sensor data 103. For example, the map generation system 102 can obtain sensor data 103 depicting areas of the property 105 from a sensor, e.g., included in the robot 120 or otherwise located at the property 105. The robot 120 can be affixed with one or more types of sensors to obtain one or more different types of sensor data. The sensor data 103 can include image data—e.g., RGB images or monochrome images. The sensor data 103 can include non-image data—e.g., depth sensor data or heat data.

The sensor data 103 can be obtained in a number of ways including through following—e.g., using the robot 120—or using other sensors at the property 105. For example, the robot 120 can follow a person or animal at the property 105, such as the person 108. Moving objects, such as animals or persons at the property, can be referred to generally as occupants which may include residents. In some cases, an occupant can take the robot 120 on a tour of the property 105 by walking one or more paths through the property 105. In some examples, the robot 120 can follow the occupant visually or using a wireless signal, e.g., from a signal emitting device of the occupant.

In some implementations, the robot 120 follows occupants. For example, without a prompt, the robot 120 can determine to follow an occupant. In some cases, time ranges or occupants can be specified for following. The robot 120 can follow, e.g., only during a specified time range, where the time range is specified by a user beforehand. The time range can be defined by a set of hours, e.g., from A am to B am, a time of day, e.g., morning or evening, or another appropriate time range. Similarly, in some cases, the robot 120 can follow only specified occupants. A processing unit of the robot 120, such as a processing unit configured to operate the map generation system 102, can obtain data indicating specified time ranges or occupants. The processing unit of the robot 120 can use visual detection algorithms using visual data, or non-visual detection algorithms using non-visual data—e.g., data from radio frequency (RF) sensors, heat sensors, depth sensors, Light Detection and Ranging (LIDAR) sensors, among others, to identify occupants to follow. The processing unit of the robot 120 can compare a current time to one or more obtained specified time ranges to determine if the current time satisfies one or more of the specified time ranges. In response to one or more of the conditions being satisfied (e.g., a current time satisfying a time range or detected occupant satisfying a specified occupant for following), the robot 120 can follow an occupant at the property 105.

In some implementations, the robot 120 follows occupants during a training period. For example, during a training period the robot 120 can follow the occupant 108 or other occupants at the property 105. In some cases, the robot 120 can follow one or more occupants until the robot 120 has captured a threshold amount of data, a threshold time period is satisfied, or a combination of both. The threshold amount of data can indicate an amount of data—e.g., 20 gigabytes, or other value-or the threshold can indicate a coverage amount—e.g., a ratio of traversed rooms compared to non-traversed rooms, where traversed rooms are rooms where the robot 120 has obtained at least a threshold amount of sensor data or spent a threshold amount of time. After the robot 120 determines—e.g., using a processing unit of the robot 120—that an obtained amount of data satisfies a threshold, the robot 120 can stop following one or more occupants.

Sensor data obtained when following an occupant can include data of the occupant, data of the surrounding area of the property 105, e.g., a room or hallway or staircase, or a combination of both. For example, the sensor data 103 can include both data of the occupant 108 and data of a surrounding area being traversed by the robot 120 or either type of data separately.

In some implementations, the sensor data 103 is obtained, at least in part, by sensors located at the property 105—such as sensors 104a-c. For example, sensors located at the property 105 can include cameras 104a and 104c, such as security cameras, at the property 105. In some cases, the property 105 is equipped with cameras or other sensors, such as sensor 104b. Sensors can include RF emitting sensors, heat sensors, depth sensors, LIDAR sensors, or a combination of these.

In stage B, an object detection engine 106 of the map generation system 102 processes the sensor data 103. For example, the object detection engine 106 can operate one or more detection algorithms to process one or more types of sensor data in the sensor data 103. The object detection engine 106 can detect the occupant 108 at the property 105 using the sensor data 103. Using a collection of sensor data over time, the object detection engine 106 can detect an object moving over time. The object moving over time can be used to detect paths for traversing portions of the property 105. Paths, detected using detected objects over time by the object detection engine 106, can be used, e.g., by a mapping engine 114, to map at least a portion of the property 105.

In the example of FIG. 1, the object detection engine 106 detects objects 110a-c. The object detection engine 106 detects object 110a using sensor data representing a portion of room D, object 110b using sensor data representing a portion of room C, and object 110c using sensor data representing a portion of room A. In some cases, the object detection engine 106 is trained to detect one or more types of objects—e.g., a couch, chair, table, human, different types of animal, among others.

In stage C, the mapping engine 114 of the map generation system 102 processes sensor data for the objects detected by the object detection engine 106. In the example of FIG. 1, the mapping engine 114 uses detected objects 110a-c to generate a map for navigation. Generating the map can include determining a permanency value for one or more detected objects, as described in more detail below.

In some implementations, sensors, such as cameras, of the property 105 are calibrated. For example, sensors can be calibrated so that the map generation system 102 can map detections from the sensor data 103 to physical positions at the property 105.

In some cases, a calibration of one or more sensors can provide some level of detail about the property 105, e.g., room layout or dimensions. By detecting occupant movement at the property 105, the map generation system 102 can obtain, infer, or a combination of both, additional information regarding objects, such as obstacles. By obtaining the sensor data 103 over time, the mapping engine 114 and the object detection engine 106 of the map generation system 102 can determine a permanency of obstacles—e.g., which obstacles are temporary (e.g. a discarded box), which obstacles are permanent (e.g. a couch), or which might be permanent but move around (e.g., a kitchen chair). The permanency can be represented by a permanency value that indicates a likelihood that the object will remain in place. Using a determination of permanency, the mapping engine 114 can determine paths at the property 105—e.g., paths that avoid obstacles or have a likelihood that does not satisfy, e.g., less than, a threshold likelihood of intersecting with an obstacle. In some cases, paths to avoid obstacles can be robot specific. For example, an aerial robot can navigate an aerial path that avoids an obstacle on the floor. A wheeled robot navigating on the floor can navigate a path that avoids an obstacle in the air—e.g., a ceiling fan.

In some implementations, the map generation system 102 generates object representations to depict features of a property that move. For example, a chair pushed in and out from a table can be represented in a floorplan as a rectangular prism. Because the chair moves, the map generation system 102 can generate a permanency value that does not satisfy a permanency threshold for localization. The generation of the object representation, e.g., a rectangular prism or other suitable three dimensional shape, can reduce a likelihood of robots running into the chair. The object representation can be generated using a set of positions for an object identified over time. If a position of an object is detected in two or more locations for a threshold amount of time or a number of detections that satisfies a threshold number of detections, the locations can be combined to form a three dimensional shape describing the area where the object might be located, e.g., the object representation. The map generation system 102 can store the object representation, or data for a region in which the object might be located, in a floorplan for the robot to use navigating around the movable object.

In some implementations, if a person moves through an area, the map generation system 102 can determine that the area at that location of the person moving, from the floor to an average height of a person or a specific height of an identified individual, is likely available for robot movement. That area can be added or updated in a floorplan to be used for navigation paths for one or more robots.

In general, the mapping engine 114 can determine different paths which may be navigable for one or more types of robot—e.g., where some paths may only be navigable for a specific type of robot. For example, the mapping engine 114 can determine a ceiling height in a given room—e.g., using one or more sensors. The mapping engine 114 can determine that a room has a ceiling height that satisfies a threshold—e.g., is less than a specified height threshold. In response, the mapping engine 114 can generate paths for navigation that avoid the room. In some cases, a room can be avoided based on other determinations. For example, the mapping engine 114 can determine that a room ceiling height satisfies a ceiling height threshold and there are people occupying the room. In response, the mapping engine 114 can generate paths for navigation that avoid the room. If no people are occupying the room, the mapping engine 114 can generate paths for navigation that include paths that go through the room. For floor going robots, the mapping engine 114 can detect stairs in a region of a property, e.g., using sensor data, and, in response, generate paths that avoid that region—e.g., when generating paths for a robot that is not equipped with features to move over stairs.

In some implementations, the mapping engine 114 determines capabilities of a robot to determine one or more areas suitable for navigation paths. For example, capabilities can include aerial movement or movement over the floor. Capabilities can include an ability to move over or otherwise avoid obstacles—e.g., an actuator that is configured to move obstacles out of the way such that the robot can pass through an area with a determined obstacle, such as a chair or ladder. In some cases, a navigation path can include going through an area with an obstacle in response to the mapping engine 114 determining a corresponding robot that will navigate the path has capabilities sufficient to avoid the obstacle—e.g., by moving or otherwise removing the obstacle or avoiding by movement capabilities. In some cases, prior to moving or otherwise disturbing elements of a property, a robot can provide a notification to a device, e.g., operated by a person at the property. In response to a confirmation input from the person—e.g., using a user device communicably connected to the robot-or a set time out period after sending a notification, the robot can move or otherwise disturb an obstacle to continue navigation.

The mapping engine 114 can store paths in the paths database 115a. The paths can indicate movement of occupants detected at the property 105. The stored paths can be used to represent reliable paths for exploration or navigation by the robot 120, can be used to generate an indication of traffic—e.g., using a heatmap-for one or more areas of the property 105, or a combination of both. Reliable paths can include paths for which a likelihood of an obstacle blocking the path does not satisfy, e.g., is less than, a threshold likelihood. The likelihood can be determined, e.g., by the mapping engine 114, using one or more permanency values for detected objects at the property 105.

In the example of FIG. 1, the map generation system 102 can determine permanency values for detected objects 110a-c. The mapping engine 114 can determine the object 110a, e.g., a vacuum, has a permanence value of 0.01 indicating that the object 110a is likely to move. The mapping engine 114 can determine the object 110b, a couch, has a permanence value of 0.95 indicating that the object 110b is not likely to move. The mapping engine 114 determines the object 110c, e.g., a counter, has a permanence value of 1.00 indicating that the object 110c is likely fixed in place. Permanence values and associated identifiers, e.g., representations, of objects can be stored by the map generation system 102 in the object permanence database 115b.

In some implementations, for objects that the mapping engine 114 determines to be constant in the room—e.g., a permanence value satisfying a permanence value threshold, the map generation system 102 stores visual representations of those constant objects to be used as landmarks for robot navigation. Using subsequent sensor data, the map generation system 102 can update representations of constant objects to better capture differences over time—e.g., lighting differences from different lighting at different times of day or under different property conditions. The map generation system 102 can obtain sensor data and compare the obtained sensor data with saved visual representations. The map generation system 102 can use the comparison to determine a variability of the object, to alert the robot 120 to a change in appearance, location, or both, of the object that satisfies a difference threshold, or a combination of both.

By detecting visual landmarks using cameras, the map generation system 102 can aid the robot 120 that might be able to detect a saved landmark but is not in range of a separate calibrated camera, is operating without connection to separate cameras, when the separate cameras are not functional, or a combination of these. A technique of landmark detection—e.g., using pre-recorded images from cameras mounted at a property or cameras on a robot-can have the advantage of being able to generate mapping data prior to the installation or purchase of a robot, which can allow assessment of viability—e.g., whether the robot would likely be able to function or would likely be able to function at, at least, a minimum functional level, where assessment can include determining factors such as whether or not the robot can navigate over a threshold space of a property-before purchasing or providing a faster path to operation for a newly installed robot. In some cases, assessment of viability can be specific to a robot with a particular set of capabilities. For example, for a given property, pre-recorded images can be used to determine if a flying robot or floor going robot or both could function. More specificity can be included in the analysis—e.g., floor going robots with wheels greater than three inches satisfy a minimum functional level. An assessment of viability can include a measure of confidence indicating a likelihood that a given robot could or could not likely function at a property.

In some implementations, the map generation system 102 uses scene segmentation and line-finding techniques to extract information. For example, the map generation system 102 can use scene segmentation and line-finding techniques to extract information that indicates a geometry of a room or contents, e.g., detected in sensor data representing a field of view of the camera.

In some implementations, the map generation system 102 determines how rooms at the property 105 are connected or otherwise relate to each other. For example, the map generation system 102 can detect the occupant 108 leaving room B through a doorway using first sensor data. The map generation system 102 can detect the occupant 108, within a time threshold range of the first detection and using second sensor data, walking in through the doorway into room D. Using the detection of the occupant 108 leaving room B and entering room D within the time threshold range, the map generation system 102 can determine that room B and room D are likely connected by that doorway.

The map generation system 102 can determine the type of doorway—e.g., a permanent opening, a sliding door, a swinging door, or a hinged door. The type of door can define a type of doorway. The type of doorway can be added to a generated mapping to aid in navigation. For instance, the navigation aid can include adjusting an opening mechanism to with a robot or connected system to open a first door along a path which adjustment can be determined given the determined door type of the first door specified in the generated mapping. Door types can include a pocket door, folding door, or a pet door, to name a few examples.

In some implementations, the map generation system 102 determines existence of areas not directly visible using sensor data. For example, if the occupant 108 exits a first room through a different doorway, then is detecting in another room a period of time later, the map generation system 102 can determine a path exists between the two rooms. The map generation system 102 can determine a predicted distance of the path between the two rooms using a detected pace of the occupant—e.g., using several detections of the occupant over time, using a detected average occupant speed, or a combination of both. The map generation system 102 can determine if one or more determinations related to a connection between regions—e.g., a distance between rooms, whether the rooms are connected, among others-satisfy a confidence threshold. If so, the map generation system 102 can store that data for use in navigation. Even if one or more determinations do not satisfy a confidence threshold or cannot be determined, the map generation system 102 can store data representing the results of other determinations. In some cases, robots or other sensors of the corresponding property can investigate a connection to inform how regions of a property are connected.

The map generation system 102 can estimate dimensions of the not directly visible area—e.g., using other data of other rooms at the property 105. In some cases, the map generation system 102 can use detected data to determine (i) that a not directly visible area likely exists; (ii) that there is a path traversing the visible area connecting two or more rooms; and (iii) a distance estimate indicating a distance between the two rooms connected by the not directly visible area. In some cases, the robot 120 can be dispatched to enter the not directly visible area to obtain additional sensor data to aid mapping of the not directly visible area.

The map generation system 102 can use sensors other than cameras to obtain sensor data. Sensor data can be used to detect cues about occupant movement, an interconnectedness of areas, or both. For example, motion or audio sensors can be used by the map generation system 102 to detect that an occupant has entered a room hidden from cameras. A radar system or system that detects Wi-Fi or other wireless signals can be used to capture movement behind a wall. The map generation system 102 can use this data to determine topology or geometry of hidden spaces.

In some implementations, the mapping engine 114 identifies hazards. Hazards can include an animal, sleeping baby, other sleeping person, an area designated by a user as off limits, among others. Hazards can be specified by a user. Hazards can be dynamic—e.g., don't enter a room with a cat detected inside, where the map generation system 102 detects the cat and, in response, identifies the known hazard of cat in room. For example, the map generation system 102 can use the sensor data 103 to detect one or more objects as hazards. The map generation system 102 can (i) use a trained model to detect one or more objects as hazards or (ii) compare one or more detections to detections associated with one or more hazards. Based on a detection comparison, the map generation system 102 can determine that one or more hazards potentially exist in one or more rooms—e.g., by comparing data from cameras or other sensors at the property 105 with known data indicating one or more hazards. Data indicating hazards can be transmitted to the robot 120 to prevent traversal of one or more areas of the property 105—e.g., areas that include one or more of the hazards. Hazards can apply to one or more robots, robot types, or a combination of both. For example, a hazard, such as a room with the cat, can apply to all robots. Another hazard, such as (i) a low ceiling basement or (ii) when a person is there, can apply to a subset or a single robot—e.g., an aerial robot or aerial robot of a particular size or with a particular set of capabilities.

During runtime, when the robot 120 enters an area of the property 105 it can obtain sensor data of that room. A processing unit of the robot 120, such as the map generation system 102, can detect visual features within the area or detect a spatial structure of the area using sensor data—e.g., sensor data obtained from sensors at the property, such as sensors 104a-c.

In some implementations, the robot 120 obtains map updates from the map generation system 102. In response to entering an area, the robot 120 can request map updates of the area from the map generation system 102. In some cases, only first visits to an area prompt requests for map updates—e.g., for a first period of time or until the map generation system 102 provides a notification to the robot 120 of a map update. A sensor that detects a change at a property can trigger the map generation system 102 to update a map, e.g., prior to a next robot mission. Updates can include detected objects or appearance information, routes determined using detected object movement traversing them, or changes in objects—e.g., a newly opened or closed door, a piece of furniture moved into a previous detected route, or a group of people gathered in a room. By updating the map, path planning by the map generation system 102 can generate a more efficient or accurate route that considers new information, e.g., as it is detected by one or more sensors.

Map updates can be linked to previous maps stored on the robot 120 for navigation—e.g., landmarks of an existing map of the robot 120 can be linked with landmarks included in an update from the map generation system 102. Linking can combine or replace data, e.g., providing new visual representations of landmarks indicating an appearance of a given object at different times of the day or different lighting conditions where a robot can change which representation of a landmark in a map to use based on a current time or lighting condition of the robot mission, such as using a current time or lighting condition as a lookup value to obtain a corresponding set of one or more landmark representations at a property. In some cases, a current time or lighting condition can be used as a starting point to search for potential matching landmark appearances—e.g., to determine nearest neighbor match or match with a lowest level of difference between appearances.

In some implementations, sensors at the property 105 are used to validate a map generated by the map generation system 102. For example, the map generation system 102 can detect the robot 120 moving through a field of view captured in the sensor data 103. One or more transformations can be performed to validate a path of the robot 120 with a perceived path of the robot 120, e.g., as described below. In some cases, the map generation system 102 can use global optimization to minimize an error between camera-derived (e.g., outside in) position of the robot 120 compared to the position of the robot 120 derived from the robot 120 (e.g., inside out).

The map generation system 102 can perform a series of transformations. Transformations can be used to validate a navigation map. Transformations from reference points can be used by the map generation system 102, e.g., where a 2D position of the robot in a camera frame is transformed using camera calibration into a 3D position of the robot in a local camera derived map. Additional transformations can be performed, e.g., the 3D position of the robot in the local camera derived map can be transformed using a 3D or 6D transform from local map to a global map to generate a camera derived 3D position of the robot in the global map. The map generation system 102 can optimize—e.g., using one or more global optimization processes-error between (i) a camera-derived position of the robot and (ii) a robot derived position of the robot.

In some cases, a calibration process can be used when installing a fixed camera—e.g., images of people standing on a floor in various locations can be used to determine a position of the camera with respect to the floor, which can be referred to as ground plane. When an object moves in a field of view of the camera, the system can use the calibration to transform the object's position within an image plane, e.g., a two-dimensional image plane, to a position on a map of the room. By estimating height, the system can predict a position of the object in a three-dimensional version of the map either in addition to or instead of a two-dimensional position. For detected objects that are robots, the system can detect the robot and use an initial calibration to determine its position. Determining the position can include using internal parameters of a camera that detects the object or a size and appearance of the robot to estimate a position or pose of the robot within a room map.

Areas visible by one or more cameras can be linked as local maps with a global map. Objects detected within local maps of a camera fields of view can be located within a larger map, e.g., a floorplan of a property that includes both a building and an outside area around the building. Locating in the larger map can use transformations to the local map and from the local map to the larger map. In some implementations, a robot localizes in response to detecting a number of landmarks above a threshold number of landmarks for localization. Localizing can include obtaining a location within a larger map, e.g., a floorplan generated or updated by the map generation system 102. In between localizations, a robot can increment its position using other processes, such as visual inertial odometry (VIO).

In some examples, a robot can move into a room that includes a camera. The camera in the room can detect the robot and estimate a position of the robot—e.g., using one or more elements of the map generation system 102. The map generation system 102 can estimate a position of the robot within a global map and compare it to a predicted location of the robot—e.g., a previous estimated location of the robot performed by the robot or the map generation system 102. In some cases, the robot can estimate a location of the camera in the room or a location of itself after detecting an obtaining a location of the camera in the room in response to detecting the camera in the room.

If the previous estimated location of a robot and a current estimate of the robot is within a threshold difference—e.g., and continues to be so as a robot moves or over a period of time—this can indicate that the corresponding maps and transforms are likely correct, e.g., within a threshold tolerance. If not, the map generation system 102 can use an optimization process to determine an improved solution. In the optimization process, the map generation system 102 can adjust one or more linkages, including one or more of the following: a transform from a camera to a local map, a relationship of a local map to a global map, a relationship of a robot's image to the local map, or the global map. Adjustment can include changing one or more values or recomputing the linkages using obtained sensor data. The map generation system 102 can use confidence values or repeated observations to determine which parts of the system are likely less accurate than others. In some cases, the map generation system 102 uses factor graphs to model this complexity.

The map generation system 102 can use collected information about areas of the property 105 to construct a 2D or 3D floorplan. A floorplan can include features, such as walls, or detected objects, such as the representation of the property 105 shown in FIG. 1.

In some implementations, the map generation system 102 generates heatmaps based on object movement. For example, the map generation system 102 can combine occupant tracking over time into a heatmap that represents areas traveled and the amount of travel in particular areas—e.g., high travel near doorways and low travel near permanent objects.

In the example of FIG. 1, the map generation system 102 generates a heatmap for the property 105 that indicates areas to avoid and areas of high traffic using the sensor data 103. The map generation system 102 detects high traffic areas 116a-d near the center portions of the rooms shown in the property 105. The map generation system 102 detects areas to avoid 118a-c. Areas to avoid can indicate areas specified by users to be avoided, areas where obstacles with permanence values below a threshold are detected at a threshold frequency—e.g., indicating that the area is not likely clear or safe to traverse for the robot 120, or a combination of both.

The robot 120 can use generated heatmaps of the property 105 to navigate the property 105. A heatmap can be associated with one or more maps. For example, the robot 120 can use generated heatmaps to find high traveled paths between waypoints or to avoid traversing or loitering in high traffic areas of the property 105. In some cases, the robot 120 can avoid paths that are frequently traveled by humans or other occupants of the property 105—e.g., to reduce a likelihood of a collision with a human or other occupant of a property or causing a disturbance. In some cases, the robot 120 can avoid high traffic areas, such as a front door area. Avoiding high traffic areas and highly traveled paths can help the robot 120 avoid collisions with, or disturbing, humans or other occupant at the property 105.

In some implementations, heatmaps of the property 105 include time ranges. For example, high traveled areas can be avoided during specific times but used for robot navigation during other times. In one example case, a particular area can be determined to have high-traffic between 6 AM and 8 AM—e.g., determined using a measure of detected objects moving in that particular area compared to one or more thresholds for moving objects, such as a threshold indicating a number of objects moving in an area within a period of time-but less traffic between 8 AM and 3 PM. The map generation system 102 can configure paths for robots in the particular area during the less traffic time period and avoid the particular area in the high-traffic time period.

In some implementations, the map generation system 102 determines temporal traffic data. For example, traffic can change based on time of day or other schedule. The map generation system 102 can generate new heatmaps, update existing heatmaps, or include temporal data in a given heatmap to indicate changes based on time of day or other schedule or criterion. In some cases, a set of heatmaps from two or more sets of heatmaps can be selected using a current time or condition of the property 105—e.g., armed or not armed. The selected set of heatmaps can be associated with a time range or one or more conditions of the property and then be used by the robot 120 to navigate the property 105 when the time range or the one or more conditions, or both, are satisfied. By using a time-based heatmap, the map generation system 102 can enable the robot 120 to travel more efficient paths at the property 105—e.g., allowing a direct path, at night, across an area that is detected to have high traffic in the morning but not at night.

A heatmap can include areas where there is variance over time. For example, while occupants might clean up clutter around a property prior to an installer visiting with a drone, in everyday situations there may be areas where items tend to be placed, clutter tends to accumulate, or items like chairs are moved frequently. Changes in objects or path traversal can be represented within the heatmap and used by the robot 120, e.g., by a processing component configured to recommend paths.

As an environment changes over time, the map generation system 102 can obtain senor data, e.g., from the robot 120 or sensors 114a-c. Changes in the environment, such as the property 105, can be detected and used by the map generation system 102 to update maps for robot navigation. For example, the map generation system 102 might detect a Christmas tree that interferes with a detected path. Without continuous or semi-continuous monitoring using property sensors, such as sensors 114a-c, the robot 120 might encounter this obstacle several times before learning that it is semi-permanent. Then, when the Christmas tree is taken down, the robot 120 would have to relearn that the path is open which might not happen if the new path it takes doesn't go near the tree. With cameras or other sensors present, the map generation system 102 can detect the tree as a semi-permanent feature and its disappearance—e.g., assigning a permanence value over a first period as 1.00 and, after detecting the tree as disappeared, can remove the tree as an object to be avoided in the generated map for navigation. The detections can occur before the robot ever visits that area.

In some cases, a robot or sensor can be placed at various points in the property 105 to collect data prior to installing or during operation of a robot.

The map generation system 102 can maintain data generated from occupant movement data captured by a device that follows a corresponding occupant. By following occupants, using the robot 120 or sensors of the property, e.g., sensors 104a-c, the map generation system 102 can determine at least one path satisfies a threshold—e.g., a path where a collision is unlikely, such as a likelihood of collision with object, human or other occupant. The map generation system 102 can determine, using the occupant movement data, how the robot 120 can navigate between rooms—e.g., how to get from room A to room B. The map generation system 102 can determine, using the occupant movement data, what rooms or other areas exist at the property 105.

While following an occupant, the robot 120 can use sensors such as cameras or lidar to observe surroundings, sense walls, or free space. A detected path, detected by the map generation system 102, can be used as a breadcrumb trail from which the robot 120 can further explore a property—e.g., using the trail as a safe location that the robot 120 can return to get back to a charger, a starting point, or another appropriate area. In some implementations, path information detected by the map generation system 102 is used to suggest a mapping trajectory to an installer before actual mapping procedure or to suggest anchor points-e.g., points to return to multiple times during mapping.

The map generation system 102 is an example of a system implemented as computer programs on one or more computers in one or more locations, in which the systems, components, and techniques described in this specification are implemented. The map generation system 102 can send or receive data over a network. The network (not shown), such as a local area network (“LAN”), wide area network (“WAN”), the Internet, or a combination thereof, can connect the map generation system 102 with the robot 120. In some cases, the computers implementing the map generation system 102 are at least partially included in the robot 120. The map generation system 102 can use a single computer or multiple computers operating in conjunction with one another, including, for example, a set of remote computers deployed as a cloud computing service.

The map generation system 102 can include several different functional components, including the object detection engine 106 and the mapping engine 114, that can include one or more data processing apparatuses, can be implemented in code, or a combination of both. For instance, each of the object detection engine 106 and the mapping engine 114 can include one or more data processors and instructions that cause the one or more data processors to perform the operations discussed herein.

The various functional components of the map generation system 102 can be installed on one or more computers as separate functional components or as different modules of a same functional component. For example, the object detection engine 106 and the mapping engine 114 of the map generation system 102 can be implemented as computer programs installed on one or more computers in one or more locations that are coupled to each through a network. In cloud-based systems for example, these components can be implemented by individual computing nodes of a distributed computing system.

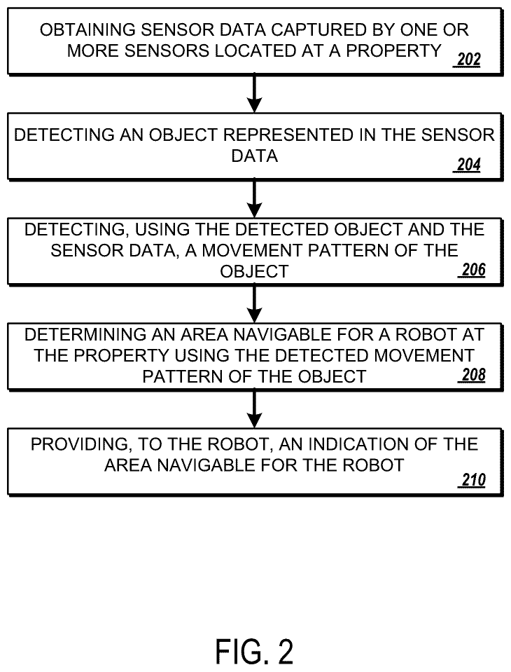

FIG. 2 is a flow diagram illustrating an example of a process 200 for robot navigation. For example, the process 200 can be used by the map generation system 102 from the environment 100.

The process 200 includes obtaining sensor data captured by one or more sensors located at a property, e.g., over a time period (202). For example, in stage A, the map generation system 102 can obtain the sensor data 103.

The process 200 includes detecting an object represented in the sensor data (204). For example, the object detection engine 106 of the map generation system 102 can detect one or more objects, such as the occupant 108, in the obtained sensor data 103.

The process 200 includes detecting, using the detected object and the sensor data, a movement pattern of the object, e.g., over the time period (206). For example, the mapping engine 114 can detect movement of an object. Movement of an object can be detected as a path and stored in the paths database 115a.

The process 200 includes determining an area navigable for a robot at the property using the detected movement pattern of the object, e.g., over the time period (208). For example, the map generation system 102 can use detected objects and paths to determine one or more navigable areas.

The process 200 includes providing, to the robot, an indication of the area navigable for the robot (210). For example, the map generation system 102 can provide the robot 120 with an indication of navigable areas—e.g., areas where occupant paths have been detected or where no objects with permanence levels below a threshold have been detected in a time period.

In some implementations, the process 200 can include additional operations, fewer operations, or some of the operations can be divided into multiple operations. For example, the process 200 can include predicting an object permanency for one or more detected objects. Object permanency can be predicted from sensor data of a detected object over a period of time. The amount of change of the object over time can be proportional to the object permanence. Permanent objects are less likely to move and less likely to change appearance compared to less permanent objects.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” refers broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

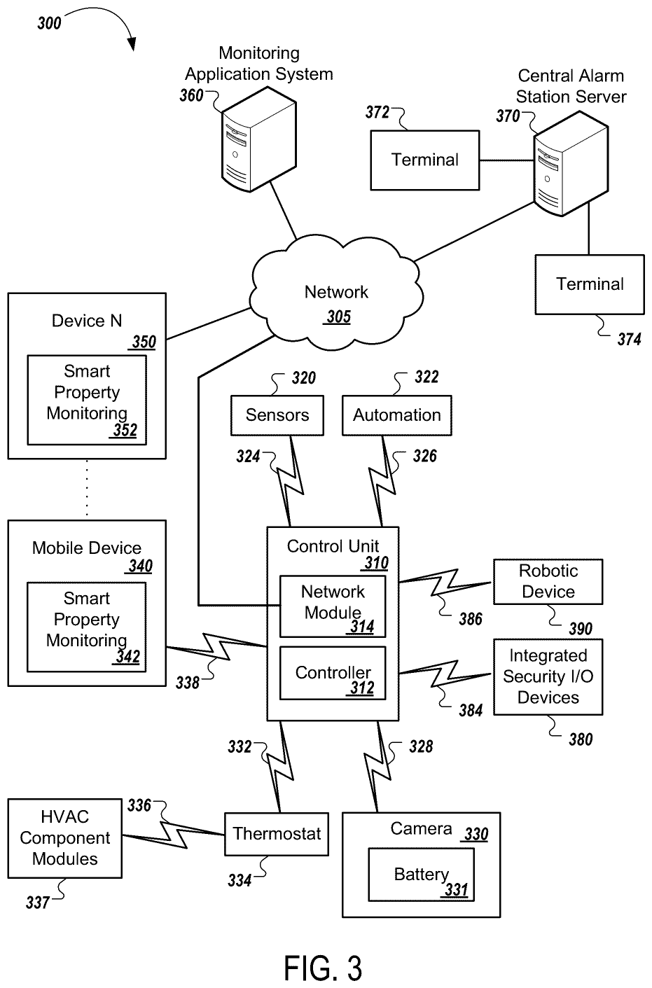

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm station server 370, or a combination of two or more of these. In some examples, the network 305 facilitates communications between two or more of the control unit 310, the one or more devices 340 and 350, the monitoring system 360, and the central alarm station server 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm station server 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heart-rate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicates with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuous, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which sensor is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environmental, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can taking actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, and the integrated security devices 380 can communicate with the controller 312 over communication links 324, 326, 328, 332, 338, 384, and 386. The communication links 324, 326, 328, 332, 338, 384, and 386 can be a wired or wireless data pathway configured to transmit signals between any combination of the sensors 320, the module 322, the camera 330, the thermostat 334, the robotic devices 390, the integrated security devices 380, or the controller 312. The sensors 320, the module 322, the camera 330, the thermostat 334, the robotic devices 390, and the integrated security devices 380 can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm station server 370, or a combination of these, over the network 305. For example, the monitoring system 360 can be configured to monitor events (e.g., alarm events) generated by the control unit 310. In this example, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm station server 370. For example, the monitoring system 360 can transmit the alert data to the central alarm station server 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm station server 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm station server 370 can be configured to monitor alerting events generated by the control unit 310. In this example, the central alarm station server 370 can exchange communications with the network module 314 included in the control unit 310 to receive information regarding alerting events detected by the control unit 310. The central alarm station server 370 can receive information regarding alerting events from the one or more mobile devices 340 and 350, the monitoring system 360, or both.

The central alarm station server 370 is connected to multiple terminals 372 and 374. The terminals 372 and 374 can be used by operators to process alerting events. For example, the central alarm station server 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm station server 370 and render a display of information using the alerting data.

For instance, the controller 312 can control the network module 314 to transmit, to the central alarm station server 370, alerting data indicating that a sensor 320 detected motion from a motion sensor via the sensors 320. The central alarm station server 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A method comprising:
obtaining sensor data captured by one or more sensors located at a property over a time period;
detecting an object represented in the sensor data;
detecting, using the detected object and multiple subsets of the sensor data, a movement pattern of the object over the time period;
determining an area navigable for a robot at the property using the detected movement pattern of the object over the time period; and
providing, to the robot, an indication of the area navigable for the robot.

2. The method of claim 1, wherein detecting the movement pattern of the object comprises:
detecting an object moving at the property.

3. The method of claim 2, wherein determining the area navigable for the robot using the detected movement pattern of the object over the time period comprises:
identifying an area traversed by the object moving at the property as the area navigable for the robot.

4. The method of claim 1, comprising:
generating a first map using the area navigable for the robot,
wherein providing the indication comprises providing the map to the robot as the indication of the area navigable for the robot.

5. The method of claim 4, comprising:
obtaining second sensor data captured by the one or more sensors located at the property over a second, different time period;
determining, using the second sensor data, a change in property condition; and
in response to determining the change in property condition, generating a second map using the second sensor data, wherein the second map is different from the first map and associated with the second, different time period.

6. The method of claim 5, wherein the change in property condition includes a change in lighting condition, and wherein generating the second map using the second sensor data comprises:
updating one or more objects represented in the first map to represent the change in lighting condition.

7. The method of claim 1, wherein the detecting the movement pattern of the object comprises:
detecting the object did not move,
wherein determining the area navigable for the robot at the property comprises determining an area that does not include an area that includes the object.

8. The method of claim 1, comprising:
generating, using the detected movement of the first object, a permanence value of the first object,
wherein determining the area navigable for the robot at the property comprises determining, using the permanence value of the first object, the area navigable for the robot.

9. One or more computer storage media encoded with instructions that, when executed by one or more computers, cause the one or more computers to perform operations comprising:
obtaining sensor data captured by one or more sensors located at a property over a time period;
detecting an object represented in the sensor data;
detecting, using the detected object and multiple subsets of the sensor data, a movement pattern of the object over the time period;
determining an area navigable for a robot at the property using the detected movement pattern of the object over the time period; and
providing, to the robot, an indication of the area navigable for the robot.

10. The media of claim 9, wherein detecting the movement pattern of the object comprises:
detecting an object moving at the property.

11. The media of claim 10, wherein determining the area navigable for the robot using the detected movement pattern of the object over the time period comprises:
identifying an area traversed by the object moving at the property as the area navigable for the robot.

12. The media of claim 9, the operations comprising:
generating a first map using the area navigable for the robot,
wherein providing the indication comprises providing the map to the robot as the indication of the area navigable for the robot.

13. The media of claim 12, the operations comprising:
obtaining second sensor data captured by the one or more sensors located at the property over a second, different time period;
determining, using the second sensor data, a change in property condition; and
in response to determining the change in property condition, generating a second map using the second sensor data, wherein the second map is different from the first map and associated with the second, different time period.

14. The media of claim 13, wherein the change in property condition includes a change in lighting condition, and wherein generating the second map using the second sensor data comprises:
updating one or more objects represented in the first map to represent the change in lighting condition.

15. The media of claim 9, wherein the detecting the movement pattern of the object comprises:
detecting the object did not move,
wherein determining the area navigable for the robot at the property comprises determining an area that does not include an area that includes the object.

16. The media of claim 9, the operations comprising:
generating, using the detected movement of the first object, a permanence value of the first object,
wherein determining the area navigable for the robot at the property comprises determining, using the permanence value of the first object, the area navigable for the robot.

17. A system comprising one or more computers and one or more storage devices on which are stored instructions that are operable, when executed by the one or more computers, to cause the one or more computers to perform operations comprising:
obtaining sensor data captured by one or more sensors located at a property over a time period;
detecting an object represented in the sensor data;
detecting, using the detected object and multiple subsets of the sensor data, a movement pattern of the object over the time period;
determining an area navigable for a robot at the property using the detected movement pattern of the object over the time period; and
providing, to the robot, an indication of the area navigable for the robot.

18. The system of claim 17, wherein detecting the movement pattern of the object comprises:
detecting an object moving at the property.

19. The system of claim 18, wherein determining the area navigable for the robot using the detected movement pattern of the object over the time period comprises:
identifying an area traversed by the object moving at the property as the area navigable for the robot.

20. The system of claim 17, the operations comprising:
generating a first map using the area navigable for the robot,
wherein providing the indication comprises providing the map to the robot as the indication of the area navigable for the robot.
